(19) United States
(12) Patent Application Publication
(10) Pub. No.: US 2019/0013131 A1
(43) Pub. Date: Jan. 10, 2019

(54) MAGNETIC LINER

(71) Applicant: RICHWOOD INDUSTRIES, INC., Huntington, WV (US)

(72) Inventors: Christopher Scott Smith, Huntington, WV (US); Glenn E. Farrow, Barboursville, WV (US)

(21) Appl. No.: 15/712,250

(22) Filed: Sep. 22, 2017

Related U.S. Application Data
(60) Provisional application No. 62/529,538, filed on Jul. 7, 2017.

(51) Int. Cl. H01F 7/02; H01F 41/00; C04B 35/10; C08F 110/02; C08L 21/00; C08L 77/10

(52) U.S. Cl. CPC H01F 7/0215; H01F 41/00; C04B 35/10; C04B 2235/3217; C08L 21/00; C08L 77/10; C08F 110/02

(57) ABSTRACT

The disclosed technology regards a magnetic liner including a liner, a plurality of magnet bases each having a recess formed on the top surface thereof, and a plurality of magnets, each magnet received and secured within the recess of a magnet base. The magnet bases are inlaid within the liner, spaced apart so that no surface of any of the magnet bases is in contact with any surface of any other magnet base. The disclosed technology further regards a method of manufacturing a magnetic liner, including applying an adhesive about each of a plurality of magnet bases, and positioning the magnet bases in a press mold. A liner material is placed above the plurality of magnet bases, and heat and pressure are applied. Finally, one magnet is secured within each magnet base.

### BACKGROUND OF THE INVENTION

The disclosed technology regards a magnetic liner having a liner material, a plurality of magnet bases independently secured within the material, and a plurality of magnets, each magnet secured within a recess formed on the top surface of each magnet base. The disclosed technology further regards a method of manufacturing a magnetic liner, using a press mold, by positioning a plurality of magnet bases within the mold, positioning a liner material above the magnet bases, applying heat and pressure to the magnet bases and liner material, and after cooling securing a magnet within a recess formed within each magnet base.

Liners are used in a variety of industrial applications to protect machinery surfaces from material impact and abrasion, such as but not limited to conveyor and material handling components including material chutes and hoppers, skirtboards, lifter bars, mills and scrubbers. In many applications, liners are affixed to the machinery by bolts or similar means of secured affixation; magnetic liners are also provided in these applications.

Magnetic liners are described and disclosed in U.S. Pat. Nos. 8,287,791 and 9,283,700. The liners disclosed in these patents include elongated bar magnets inserted into grooves formed in ultra-high molecular polyethylene or polyurethane materials and extending the length of the liner, as well as polyurethane liners with elongated ferrous bars positioned within a polyurethane material, each ferrous bar bridging a plurality of magnets for the stated purpose of interlinking magnetic elements and spreading the magnetic flux.

Other magnetic liners suitable for use include rubber liners having a plurality of elongated ferrous bars positioned within the liner material, with a plurality of magnets positioned in recesses on the exposed surface of each ferrous bar, as depicted in FIGS. 1A, 1B, 2A and 2B of the present disclosure.

These magnetic liners of the prior art are susceptible to warping during and after the molding process. Warping results from the significantly higher coefficient of thermal expansion of some liner materials (e.g., rubber), than the coefficient of thermal expansion of the ferrous material of the elongated bar. Therefore, when the liner cools it has a tendency to shrink more in the rubber areas and less in the steel areas.

Furthermore, the use of elongated ferrous bars in the prior art limit the flexibility of design of individual liners, and require a significant inventory of differently sized elongated ferrous bars to provide varying sizes of liners for particular applications. Likewise, the elongated ferrous bars provide undesired rigidity to the liner, which may cause the liner to be dislodged when impacted by materials transported through the lined structure.

The magnetic liners of the disclosed technology overcome these drawbacks. Specifically, as the rubber is physically bonded to the steel by heat activated adhesive in the molding process of the disclosed technology, the liner does not shrink in the areas wherein the magnet bases are positioned. Additionally, because the magnet bases are compact and each secure a single magnet, magnet bases may be positioned within a liner to optimize the configuration of each liner based upon intended use, and inventory of magnet bases may be significantly reduced because of their universal application to varying sizes and designs of liners. Surprisingly, the use of a single magnet base for supporting a single magnet (and not a plurality of magnets) does not reduce the magnetic strength of the magnet/ferrous material combination, as suggested by the prior art wherein multiple magnets were affixed to a ferrous material. Further, the smaller magnet bases increase flexibility of the liner to better maintain contact with a metal chute or other structure to which the magnetic liner is magnetically secured, while being subjected to impact from materials. Finally, the disclosed technology results in a significant reduction in weight for the magnetic liner, as compared to the weight of the prior art magnetic liners of FIGS. 1A, 1B, 2A and 2B.

### BRIEF SUMMARY OF THE INVENTION

The disclosed technology regards a magnetic liner including a liner, a plurality of magnet bases each having a recess formed on the top surface thereof, and a plurality of magnets, each magnet received and secured within the recess of a magnet base so that the exposed face of the magnet is flush with the top surface of the magnet base when the magnet is seated within the magnet base. The magnet bases are inlaid within the liner so that the body of each magnet base is supported and affixed within the liner, with its top surface substantially or completely exposed and flush with the bottom surface of the liner. Furthermore, the magnet bases are spaced apart within the liner so that no surface of any of the magnet bases is in contact with any surface of any other magnet base.

The disclosed technology further regards a method of manufacturing a magnetic liner, including applying an adhesive about each of a plurality of magnet bases, and positioning the magnet bases in a press mold so that no magnet base touches another magnet base. Each magnet base includes a recess on the surface thereof, and the recesses are positioned at the base of the mold. A liner material is then placed above the plurality of magnet bases; in some embodiments a plurality of ceramic dowels are also placed in the mold, above the liner material. Heat and pressure are then applied by the press mold to secure the magnet bases (and the dowels, if any) within the liner material. Finally, after the liner material and magnet bases are cooled, a magnet is secured within each magnet base.

### BRIEF SUMMARY OF THE SEVERAL VIEWS OF THE DRAWINGS

FIG. 1A depicts a magnetic liner of the prior art, viewed from the bottom;

FIG. 1B depicts the magnetic liner of FIG. 1A, viewed from an end;

FIG. 2A depicts a magnet base of the prior art, with recesses for magnets, viewed from the top;

FIG. 2B depicts the magnet base of FIG. 2A, viewed from an end;

FIG. 3A depicts an embodiment of the magnetic liner of the disclosed technology, viewed from the bottom;

FIG. 3B depicts the magnetic liner of FIG. 3A, viewed from an end;

FIG. 4A depicts an embodiment of the magnet base of the disclosed technology, with a recess for a magnet, viewed from the top;

FIG. 4B depicts the magnet base of FIG. 4A, viewed from an end;

FIG. 5A depicts an embodiment of the magnetic liner of the disclosed technology, with ceramic dowels inlaid therein, viewed from the top; and

FIG. 5B depicts the magnetic liner of FIG. 5A, viewed from an end.

### DETAILED DESCRIPTION OF THE INVENTION

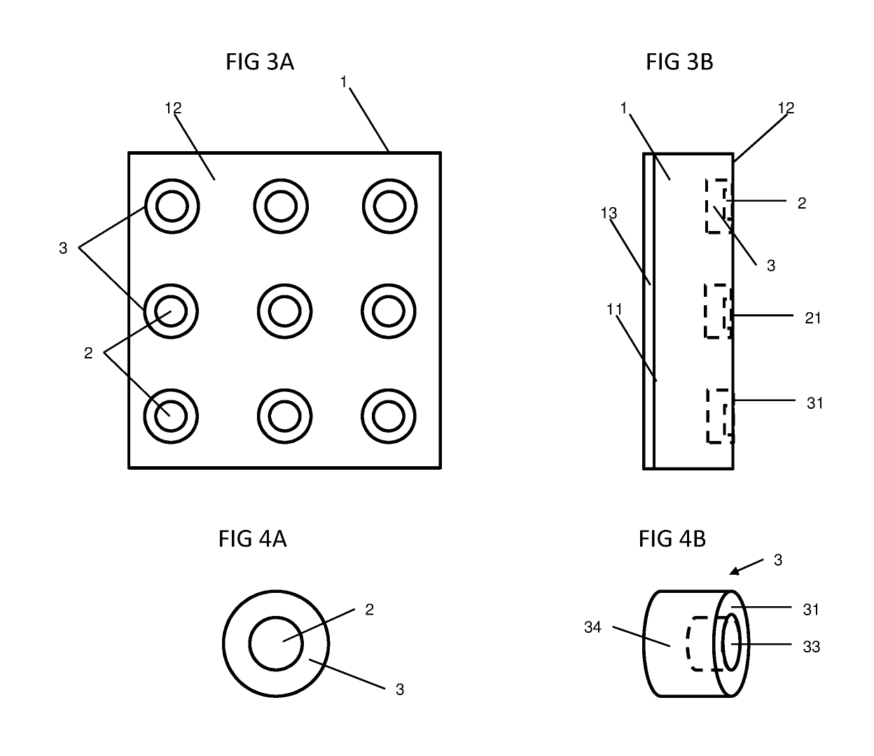

As shown in FIGS. 3A and 3B, the magnetic liner of the disclosed technology includes a liner 1 and a plurality of magnet bases 3, wherein the magnet bases are inlaid within the liner so that the body 34 of each magnet base is supported and affixed within the liner, with its top surface 31 exposed and flush with the bottom surface 12 of the liner. The magnet bases are spaced apart within the liner so that no surface of any of the magnet bases is in contact with any surface of another magnet base; in some configurations, the liner fills the spaces between the magnet bases.

The disclosed technology further includes a plurality of magnets 2, each magnet received and secured within a recess 33 on the top surface of each magnet base (as shown in FIGS. 4A and 4B). In this configuration, the recess of the magnet base is shaped and sized to receive one magnet, with the exposed face 21 of the magnet flush with the top surface of the corresponding magnet base. The magnets may be secured in the recess of the magnet base by, for example, urethane or polyurethane adhesives.

As shown in FIGS. 3A and 3B, magnets suitable for use in the disclosed technology may have an elliptical or polygonal shape (or similar shape, which is preferably but not necessarily equilateral), such as for example circular, rectangular, or hexagonal. The magnets may be defined by a height of between 1/16″-¼″, or about 0.125″. In the embodiment shown, the recess of the magnet base has a depth equivalent to the height of the magnet, so that the exposed face of the magnet is flush with the top surface of the magnet base when the magnet is seated within the magnet base. In the shown embodiment, the exposed face of the magnet may have a surface area of between 0.307 in²-1.766 in², or about 0.817 in², and the corresponding recess of the magnet base has a slightly larger cross-sectional area (e.g., an increase in area of 0.016 in²) to ensure secure and effective seating of the magnet within the magnet base recess.

The pull force of the magnets required or desired for use of the disclosed technology varies depending on, for example, the thickness and material of the liner and the intended use of the system. In some embodiments, the pull force of the magnets within the liner may be between about 500-700 lbs./ft² of liner, or about 600 lbs/ft². Magnets suitable for use in the disclosed technology include but may not be limited to permanent magnets, including neodymium and other rare earth magnets.

As shown in the embodiment of FIGS. 3A and 3B, the magnet base may be elliptical or polygonal in shape (or similar shape, which is preferably but not necessarily equilateral), such as for example circular, rectangular, or hexagonal; regardless of shape, rounded edges reduce the risk of rubber cut and tear at the rubber to steel bond surface. The surface area of the top surface of the magnet base (disregarding the depth of the recess) may be between about 1 in² and 5.83 in², or 2.76 in², or between about two to four, or three and one-third, times the surface area of the exposed face of the magnet. The magnet bases have a height of between about ⅛″-½″, or about ¼″, or about twice the height of the recess (and the height of the magnet). The area of the magnet base below the recess is solid, providing support for the magnet within the recess and resulting in a significant increase in magnetic field strength over the pull force of the magnet alone. The magnet bases may be made from a ferrous metal, such as 1018, 1020, 1045, A36 steel.

In testing, a 1″ diameter by ⅛″ thick N52 neodymium magnet having a pull strength of about 15.6 lbs., secured within a recess of the magnet base as hereinabove described, the magnet base having a height of ¼″ and a diameter of 1⅞″ (disregarding the depth of the recess), produced about 70.5 lbs. of pull strength, or about 4½ times the pull strength of the magnet alone.

The liner may be made from rubber; urethane may be another suitable liner material. In the embodiment shown in FIGS. 3A and 3B, the liner may have a depth of between ¾″ and 4″, or 1.5″; in some embodiments, the liner has a depth of between three and sixteen times, or six times, the depth of the magnet base.

A wear surface 13 may be integrated with or affixed to the top surface 11 of the liner. The wear surface may have a thickness of between about ¼″ and ¾″, or about ½ of the thickness of the overall liner. In embodiments of the disclosed technology, the wear surface may be a layer of ultra-high-molecular weight polyethylene (UHMW) or similar plastics, impregnated rubber (including, for example, Kevlar), or ceramic tiles. The wear surface would typically (but not necessarily) be molded to the base rubber layer; for wear surfaces including UHMW, for example, a thin layer of finely ground polyethylene powder is placed between a top UHMW layer and a base rubber layer, before molding the layers together. For impregnated rubber wear surfaces, the layers may be placed in the mold, with the impregnated layer on top, and upon application of heat and pressure in the molding process the impregnated rubber top layer may crosslink with the rubber base layer. Ceramic tiles may form the wear surface by applying a cement to the tiles suitable to hot bond the tiles to the rubber in the molding process.

When inlaid within the liner, the magnet bases are separated one-from-another by at least ½″, or by 1″-6″. In the embodiment shown in FIGS. 3A and 3B, nine magnet bases are inlaid equidistantly throughout the liner; however, the disclosed technology is adaptable to allow for any number and position of magnet bases, thereby offering flexibility to easily address variations in size and intended purposes of the magnetic liner. In some configurations, more magnet bases may be positioned near one or more sides of the liner, and fewer magnet bases may be positioned at other portions of the liner, depending on the desired areas of magnetic strength in use of the liner. Therefore, the flexibility in design afforded by the disclosed technology allows liners to have magnet bases positioned closer (and in greater number) near the an end of the liner, or about the edges, or in other configurations as desired for the intended purposes of the liner, so that the placement of the magnet bases may maximize the magnetic holding force on the liner based upon system configuration.

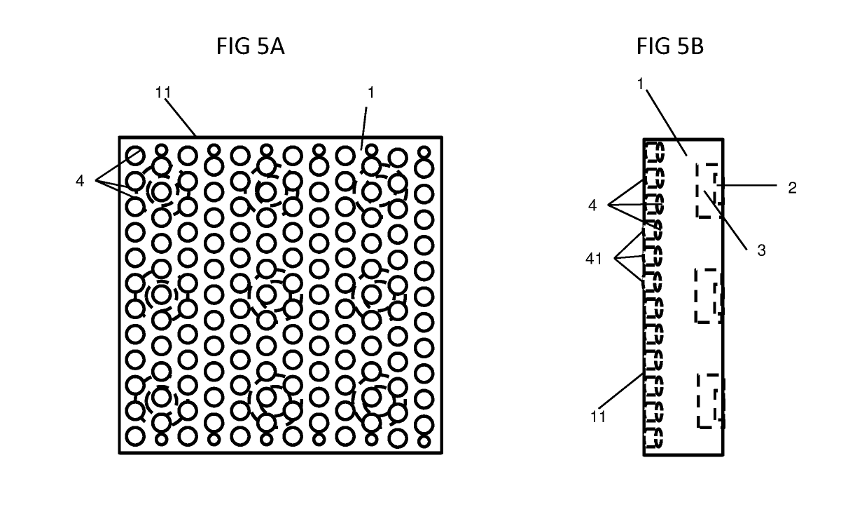

In some embodiments, as shown in FIGS. 5A and 5B, the magnetic liner of the disclosed technology further comprises a plurality of ceramic dowels 4, such as high alumina oxide solid ceramic dowels, to provide abrasion resistance to the liner. Suitable ceramic dowels include 85-96% alumina oxide; or 92-94% alumina oxide. The dowels may have a length and diameter of ½″, up to 1¼″. As shown in the depicted embodiment, the dowels may vary in size to facilitate offset among rows of dowels, providing further and consistent strength within the liner. As shown in FIG. 5B, these dowels are inlaid within the liner so that the body of each ceramic dowel is supported and affixed within the liner; the top surface 41 of each dowel may (or may not) be exposed and flush with the top surface 11 of the liner. The ceramic dowels are spaced apart within the liner so that no surface of any of the ceramic dowels is in contact with any surface of another ceramic dowel; in some configurations, the liner fills the spaces between the ceramic dowels. Ceramic brick may also be suitable for such purposes.

The equivalent impact force (F) of an object on a liner (such as debris, coal or other objects which the liner will be subjected to) can be determined from the equation:

F=W+\sqrt{2 kWh/12}

wherein k is the spring constant of the rubber, W is the weight of object, and h is the height of the object drop. Therefore, using a spring constant of 450 for steel backed rubber, estimating the maximum object weight at 50 lbs., and the maximum height of the object drop at 84″, the equivalent impact force is 611 lbs/ft². The number of magnet bases (with magnets) n having a magnetic pull force of Fₚ required to withstand a particular impact force F, can be determined by the following equation:

n=F/Fₚ

Therefore, if each magnet/magnet base has a pull force of 70.5 lbs/ft², then to withstand 611 lbs/ft² impact force would require about 9 magnets per square foot (611/70.5=8.7).

In manufacturing the magnetic liner of the disclosed technology, the magnet bases are positioned in a press mold (with the recesses positioned at the base of the mold), and the liner material is placed thereabove. Ceramic dowels, if any, are positioned above the liner material. Likewise, any wear surface may be positioned above the liner material (with adhesive, if necessary). Heat (about 300° F.) and pressure (about 350 psi) are applied by the press mold to secure the magnet bases within the liner material. To further secure the magnet bases within the liner material, heat activated adhesives used to bond rubber compounds to metal may surround each magnet base when positioned in the press mold. Suitable heat activated adhesives useful for this purpose include those manufactured by Lord Corporation under the trademark Chemlok®. In this embodiment, when the press mold applies heat and pressure to the magnet bases and liner material, the magnet bases are bonded into the liner material.

After the magnet bases are molded within the liner, and the same have cooled sufficiently, one magnet is secured within each magnet base, using for example a urethane or polyurethane adhesive within the recess of the magnet base. The magnets should not be inserted into the recesses during the press mold process, as the heat from the process would degrade the strength of the magnet. By its magnetic field strength and the adhesive, the magnets are secured within the magnet bases and the magnetic liner is available for use.

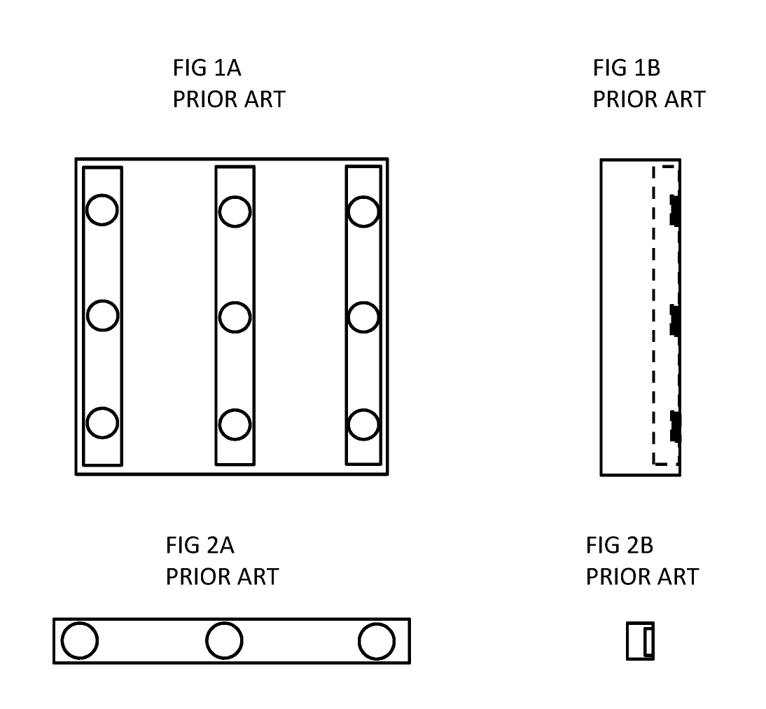

In manufacture, a 15% reduction in weight was realized by use of the disclosed technology for a rubber liner over the prior art liner depicted in FIGS. 1A and 1B, and a 5-8% reduction in weight was realized for the disclosed technology for a rubber liner over the same prior art, each with ceramic dowels incorporated in the liner.

1. A magnetic liner comprising a liner, a plurality of magnet bases having a recess formed on the top surface thereof, and a plurality of magnets, each magnet received and secured within the recesses of the magnet bases so that the exposed face of the magnet is flush with the top surface of the magnet base when the magnet is seated within the magnet base;
wherein the magnet bases are inlaid within the liner so that the body of each magnet base is supported and affixed within the liner, with a top surface of the magnet base exposed and flush with a bottom surface of the liner; and
wherein the magnet bases are spaced apart within the liner so that no surface of any of the magnet bases is in contact with any surface of any other magnet base.

2. The magnetic liner of claim 1, wherein the liner fills the spaces between the magnet bases.

3. The magnetic liner of claim 1, wherein the magnet, the recess of the magnet base and the magnet base are each circular in shape.

4. The magnetic liner of claim 1, wherein the pull force from the magnets and magnet bases is between about 500-700 lbs./ft² of liner.

5. The magnetic liner of claim 1, wherein a surface area of the exposed potion of the magnet base is between two and four times a surface area of the magnet.

6. The magnetic liner of claim 1, wherein the magnet bases comprise a ferrous metal, and the magnets comprise a neodymium magnet

7. The magnetic liner of claim 1, wherein the liner is made from rubber.

8. The magnetic liner of claim 1, wherein the liner has a depth of between three and sixteen times a depth of the magnet base.

9. The magnetic liner of claim 1, wherein the liner further comprises a wear surface as the top surface of the liner, the wear surface selected from the group consisting of: ultra-high-molecular weight polyethylene (UHMW), Kevlar impregnated rubber, and ceramic tiles.

10. The magnetic liner of claim 1, wherein the magnet bases are separated one-from-another by between ½″ and 6″.

11. The magnetic liner of claim 1, wherein the magnet bases are inlaid equidistantly throughout the liner.

12. The magnetic liner of claim 1, further comprising a plurality of ceramic dowels inlaid within the liner so that the body of each ceramic dowel is supported and affixed within the liner.

13. The magnetic liner of claim 12, wherein the ceramic dowels vary in size.

14. The magnetic liner of claim 12, wherein the ceramic dowels are spaced apart within the liner so that no surface of any of the ceramic dowels is in contact with any surface of another ceramic dowel.

15. A method of manufacturing a magnetic liner, the method comprising the steps of:
positioning a plurality of magnet bases in a press mold such that no magnet base touches another magnet base, each magnet base having a recess positioned at the base of the mold;
placing a liner above the plurality of magnet bases;
applying heat and pressure by the press mold to secure the magnet bases within the liner, wherein a top surface of each magnet base is exposed and flush with a bottom surface of the liner; and
securing one magnet within each magnet base.

16. The method of claim 15, further comprising the step of positioning a plurality of ceramic dowels above the liner in the press mold before applying heat and pressure.

17. The method of claim 15, further comprising the step of positioning a wear surface above the liner in the press mold before applying heat and pressure.

18. The method of claim 15, further comprising the steps of:
applying heat activated adhesives to each magnet base when positioned in the press mold; and
applying a urethane or polyurethane adhesive within the recess of the magnet base, to secure the magnets within the magnet bases.
